(19) United States
(12) Patent Application Publication
(10) Pub. No.: US 2019/0315631 A1
(43) Pub. Date: Oct. 17, 2019

(54) PORTABLE SYSTEM FOR THE CLARIFICATION OF DIRTY WATER

(71) Applicant: Raul Vazquez Garcia, Torrance, CA (US)

(72) Inventor: Raul Vazquez Garcia, Torrance, CA (US)

(21) Appl. No.: 15/954,974

(22) Filed: Apr. 17, 2018

(51) Int. Cl. C02F 1/00

(52) U.S. Cl. CPC C02F 1/004; C02F 2209/03; C02F 2201/008; C02F 2201/005

(57) ABSTRACT

This invention relates to a system that stores dirty water in a container and utilizes a pump and filter to clean the dirty water by retaining the dirt molecules at a minimum of 20 micros per unit. The clean water is then returned to the container. The filter has the capacity to filter water at a velocity of 340 liters per minute. The system was created to save water, help the environment, save valuable time when it comes to clarifying water, and to generate economical remuneration for the user. The invention does not necessarily need to be connected to a water source in order to function. At the same time, the invention also relies on a mobile base that allows it to move to the areas where the clean water is needed. This invention will be of great use to those who want to work in construction and help the environment at the same time.

### FIELD OF THE INVENTION

The objective of the aforementioned invention is to provide a portable system that stores dirty water in a container that is the preferred capacity of 150 gallons, which is then suctioned by a pump into a filter with a cartridge that then cleans the water and retains the dirt molecules in order to return the now clean water to the container. Said filter has a capacity to filter the water at a velocity of 90 gallons per minute, and the said invention relies on a mobile base to enable easy transportation.

The aforementioned invention was created to save water, help the environment, save valuable time when it comes to clarifying water, and to generate economical remuneration for the user.

### BACKGROUND OF THE PRESENT INVENTION

In reality, there is a grand variety of tanks for the clarification of water, the most common are cisterns or water tanks, both of which can be used in residential or industrial zones. Both also function by means of a water container that directly connected to the public water pipelines and then the water in said containers is passed through a filter either by pump for that added pressure or just by gravity. Although similar in concept, these systems are different from the aforementioned invention because this invention does not necessarily need to be connected to a water source in order to function. At the same time, this invention also relies on a mobile base that allows it to move to the areas where the clean water is needed.

### SUMMARY OF THE INVENTION

This invention shows a system that stores dirty water in a container and utilizes a pump and filter to clean the dirty water by retaining the dirt molecules at a minimum of 20 micros per unit. The clean water is then returned to the container. Said filter has the capacity to filter water at a velocity of 340 liters per minute, he aforementioned system was created to save water, help the environment, save valuable time when it comes to clarifying water, and to generate economical remuneration for the user. this invention does not necessarily need to be connected to a water source in order to function. At the same time, this invention also relies on a mobile base that allows it to move to the areas where the clean water is needed. This invention will be of great use to those who want to work in construction and help the environment at the same time.

### BRIEF DESCRIPTION OF THE FIGURES

FIG. 1 is a lateral view of the diagram of the portable system for the clarification of dirty water.

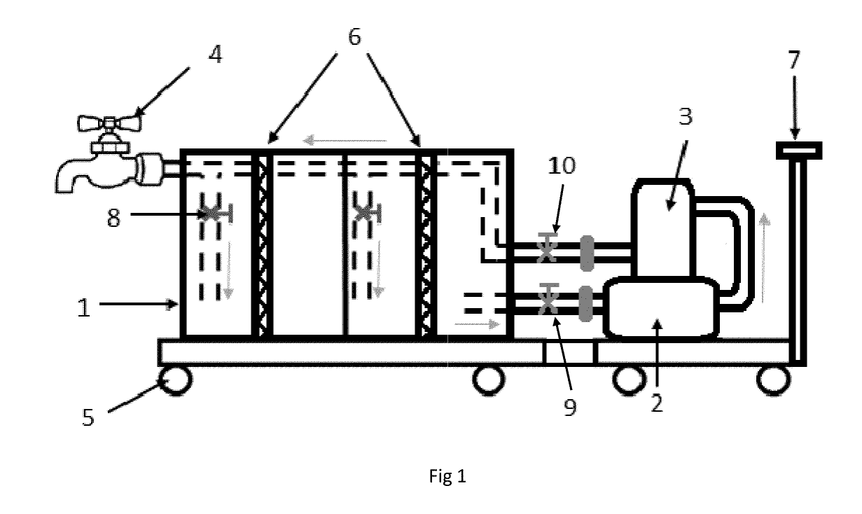

### DETAILED DESCRIPTION OF THE INVENTION

The present invention shows a portable system for the clarification of dirty water which is composed of a container (1) preferably a 600-liter capacity and which relies on an orifice on the superior portion and an interior division to allow for two internal cavities in the container, one for the dirty one and one for the recycled water. At the same time, said container (1) is connected to an electric pump (2) so that water of approximately 0.75 horse power and that functions at a preferred 110 volts. Said pump allows for the water to be suctioned into a filter (3) with a cartridge with a filtration area of approximately 150 square feet, or 45 meters squared. The filter exit (3) is connected to a discharge valve (4) that allows the water to exit. The filter (3) is also connected to a feedback pipe that returns water into each of the containers (1) cavities. The invention also features a mobile base (5) on which the entire system is rested on and also relies on various wheels that are assembled onto the base that allow the invention to be moved wherever it is needed. The feedback valve that exits into the two container divisions (1) relies on a shut-off valve (8) in each of the compartments that allow the water to be turned on and off. This gives the user control to determine where the water will be going, into the dirty water or the clean water, and/or to maintain the pressure of the exiting water.

The container (1), the electric pump (2), the filter (3) and the discharge valve (4) are connected through a PVC pipe of approximately 1½ inches or 1 inch. At the same time, they rely on PVC elbows and adaptors of the same measurements as the aforementioned pipes. Said invention relies on various security belts that surround the container (1) and securely attach it to the mobile base (5).

The mobile base (5) relies on a plank with a handle (7), preferably on one of its sides, which allows the invention to be easily moved.

The discharge valve (4) relies on a ¾ tread.

The filter (3) needs an air pressure meter in order for it to have optimum filtration and for the user to know when the cartridge needs to be changed.

### Example of Functionality

Dirty water collects in the corresponding cavity of the container until it has reached its maximum capacity, it is then that the water begins to be filtered. The water pump, which is previously connected to an outlet of 110 volts, suctions the dirty water through the filter where the dirt particles are captured. The filtered water is then returned to whichever section of the container the user decides. Alternatively, the user can also decide to maintain the valve open for the recycled water to be let out and used.

What is claimed is:

1. A portable system for the clarification of dirty water comprising:
a container which has an orifice on a top portion and an interior division to create a first cavity for the dirty water and a second cavity for the filtered water;
wherein the container is connected to an electric pump which allows for water to be pushed through a filter into the corresponding cavity;
wherein said filter is connected to an exit valve that allows a user to dictate where the water flows to, as well as to two feedback valves that allows the water to be sent back into the container;
wherein the portable system includes a movable base on which the container sits, the movable base including wheels to move the system.

2. The portable system for the clarification of dirty water according to claim 1, wherein a feedback exit present in each of the cavities of the container relies on a passage valve that is also in each of the cavities that allow the user to turn the valves on and off; wherein the valves allow the user to place the recycled water into the dirty water cavity and into the clean water cavity and/or out of the container through the discharge valve for immediate use.

3. The portable system for the clarification of dirty water as confirmed in claim 1, wherein the container, the electric pump, the filter, and the discharge valve are connected by a PVC pipes of between 1 to 1½ inches in diameter, as well as PVC elbows and adapters of the same dimensions of the PVC pipes.

4. The portable system for the clarification of dirty water as confirmed in claim 1, wherein the system includes several security belts surrounding the container to fastening of the container onto the movable base.

5. The portable system for the clarification of dirty water as confirmed in claim 1, wherein the movable base includes a plank with a handle on one side to allow the system to be easily moved.

6. The portable system for the clarification of dirty water as confirmed in claim 1, wherein the discharge valve includes a ¾ tread.

7. The portable system for the clarification of dirty water as confirmed in claim 1, wherein the filter includes an air pressure meter.
